(19) United States
(12) Patent Application Publication
(10) Pub. No.: US 2005/0244702 A1
(43) Pub. Date: Nov. 3, 2005

(54) Separator and fuel cell using that separator

(76) Inventor: Munehisa Horiguchi, Aichi (JP)

Correspondence Address: LORUSSO, LOUD & KELLY, 3137 Mount Vernon Avenue, Alexandria, VA, 22305, US

(21) Appl. No.: 11/108,057

(22) Filed: Apr. 18, 2005

(30) Foreign Application Priority Data
Apr. 28, 2004 (JP) 2004-133149

(51) Int. Cl. H01M 2/00

(52) U.S. Cl. 429/34; 429/129; 429/147

(57) ABSTRACT

A separator includes an imperforate separator substrate and spacer plates that are interposed between electrodes and the separator substrate. The spacer plates are formed of mesh and have rectangular wave-shaped cross-sections. Top portions of the rectangular waves that abut against the electrodes serve as gas diffusion portions. Adjacent side portions and portions between waves together are rectangular and serve as spacer portions which define gas passages between the gas diffusion portions and the separator substrate. Air holes that provide intercommunication between adjacent gas passages are provided in the spacer portions. As a result, gas can be supplied downstream of a gas passage that has become narrow or blocked due to a water droplet remaining in the passage.

### BACKGROUND OF THE INVENTION

1. Field of the Invention

The present invention relates to a fuel cell, and more particularly, to a separator interposed between single cells of a fuel cell.

2. Description of the Related Art

Various types of fuel cells exist, one of which is a polymer electrolyte fuel cell that is particularly well suited for use in vehicles due to its small size which is made possible by a low reaction temperature. This type of fuel cell is a stacked structure in which units of membrane electrode assemblies (MEAs), each MEA having a polymer electrolyte membrane sandwiched between two gas diffusion electrodes (each of which includes a catalyst layer and a porous support layer (i.e., a gas diffusion layer)), are stacked with a separator that also acts as a supply channel for reaction gases such as hydrogen (i.e., the fuel gas) and oxygen (i.e., the oxidizing gas) arranged on the outside of each MEA. The separator both acts as an impermeable barrier that prevents the reaction gases from permeating MEAs that are adjacent in the stacking direction, and collects power in order to extract the generated electric current to the outside. The MEA and separator together constitute a single cell unit. In an actual polymer electrolyte fuel cell, many of these single cell units are stacked together in series to form a cell module.

In order to maintain sufficient power generation efficiency with polymer electrolyte fuel cells, the electrolyte membrane must be kept sufficiently moist. Since the moisture from only the water produced by the electrolytic reaction may not be sufficient, it is generally necessary to provide a mechanism to supply humidifying water to each MEA. Further, the electrolytic reaction generates heat of a heat quantity that substantially corresponds to the power generated, so a cooling mechanism must be used to prevent the fuel cell itself from heating up excessively.

In order to wet and cool the electrolyte membrane as described above, the applicant proposed technology which mixes humidifying water in a mist state with the reaction gas to be supplied to the air electrode, and then supplies that mixture to the gas diffusion electrode. In attempt to improve manufacturability of the separator and make the fuel cell thinner, this technology employs a structure in which the separator is a corrugated (i.e., wavy) thin metal plate with air holes provided in a portion midway between the mountain peaks and the mountain bases in the corrugated plate. The reaction gas and the humidifying water which has been vaporized by heat from the separator are then supplied to the gas diffusion electrodes through these air holes.

With this structure, the wavy shape of the separator enables both the gas supply passage to be divided up so that the reaction gas can be evenly supplied to the electrodes. Furthermore, the cooling efficiency can be improved by using the vaporization of the humidifying water within the gas supply passages for latent heat cooling as well.

Japanese Patent Laid-Open Publication No. 5-29009 proposes a molten carbonate fuel cell, in which the electrodes do not need to be kept moist, where the separator is formed of a thin metal plate. In this related art, the portion (i.e., the collector) that abuts against the electrodes is a flat metal plate with holes in it, and the portion that forms the gas supply passage (i.e., a flow path plate which serves as a spacer) is a wavy shaped metal plate with holes in it that has been press formed.

Japanese Patent Laid-Open Publication No. 644981 also discloses art of a similar structure. In this technology, units of a solid electrolyte plate with an electrode integrally formed on each side are stacked together via a porous conductive flat plate, a porous corrugated plate which serves as a conductive spacer, and a separator provided with flat-bottomed depressed portions or the like on both sides.

The technologies disclosed in Japanese Patent Laid-Open Publication No. 5-29009 and Japanese Patent Laid-Open Publication No. 6-44981 are intended to be applied to molten carbonate fuel cells, so they can not be applied to fuel cells in which the electrolyte contains water, such as polymer electrolyte fuel cells. The reason for this is because the related art employs a structure in which the flow path plate or the conductive spacer contacts the electrode via the collector or the conductive flat plate. As a result, the gas supply passages become narrow due to the holes being offset at the portion where the flow path plate or the conductive spacer and the collector or the conductive flat plate overlap. If water produced from the reaction or a droplet of water that is supplied adheres to that narrow portion, it may close off the flow path thereby preventing the supplied gas from diffusing to the electrode.

### SUMMARY OF THE INVENTION

In view of the foregoing problems, the main object of the present invention is to provide a simple separator structure that has high manufacturability, which can ensure the supply of gas to an electrode by preventing a gas supply passage from becoming narrow or blocked due to supplied water or water produced from a reaction, while providing cooling, maintaining membrane moisture, and reducing power collection resistance in a fuel cell in which the electrolyte contains water.

In order to achieve this object, the present invention provides a separator which is inserted between single cells of a fuel cell, each single cell having an electrolyte which contains water sandwiched between electrodes, in order to stack the single cells together. The separator is characterised in that it includes an imperforate separator substrate and spacer plates that are interposed between the electrodes and the separator substrate, and the spacer plates are formed of mesh and have rectangular wave-shaped cross-sections, top portions of the rectangular waves that abut against the electrodes serving as gas diffusion portions and adjacent side portions and portions between waves together being rectangular and serving as spacer portions which define a plurality of gas passages between the gas diffusion portions and the separator substrate, and air holes that provide intercommunication between adjacent gas passages being provided in the spacer portions.

In this structure, the air holes in the spacer portions are preferably formed in a network.

Next, the invention provides a fuel cell in which single cells of the fuel cell, each single cell having an electrolyte which contains water sandwiched between electrodes, are stacked together with a separator sandwiched in between. The fuel cell is characterised in that the separator includes an imperforate separator substrate and spacer plates that are interposed between the electrodes and the separator substrate, and the spacer plates are formed of mesh and have rectangular wave-shaped cross-sections, top portions of the rectangular waves that abut against the electrodes serving as gas diffusion portions and adjacent side portions and portions between waves together being rectangular and serving as spacer portions which define a plurality of gas passages between the gas diffusion portions and the separator substrate, and air holes that provide intercommunication between adjacent gas passages being provided in the spacer portions.

In this structure, the air holes are preferably formed in a network of wire mesh.

According to the present invention, diffusion of the supplied gas is improved because the spacer portions which have rectangular wave-shaped cross-sections serve as gas passages and the gas is supplied directly to the electrodes through the mesh gas diffusion portions of the spacer plates.

Also, the gas passages, which are divided due to the shape of the spacer plates which have rectangular wave-shaped cross-sections, are intercommunicated with each other through air holes so even if water remains in the form of a water droplet on the electrode on the oxidation electrode side so that a gas passage becomes narrow or blocked, gas can bypass that portion and be supplied through the air holes from an adjacent flow path. As a result, gas can be diffused evenly to the electrode past the narrow or blocked portion.

Also, because the contact between the electrodes and the gas diffusion portions of the spacer plates is contact with mesh having a large aperture ratio, sufficient gas diffusion is made possible, while an even contact surface with high contact pressure from contact with the fine wire mesh can be ensured over the entire gas diffusion portion. As a result, power collection resistance can be inhibited from increasing, while the spacer plates serve as collection members.

Furthermore, when the air holes are formed in a network, the spacer plates can be formed by bending a mesh member, so the manufacturability of not only the separator, but also the fuel cell, can be improved by a simple process that does not require a high degree of skill.

### BRIEF DESCRIPTION OF THE DRAWINGS

FIG. 1 is a block view of a fuel cell system;

FIG. 2 is a plan view of a cell module which forms a fuel cell stack according to a first exemplary embodiment of the present invention;

FIG. 3 is a front view of the cell module as viewed from an air electrode side;

FIG. 4 is a front view of the cell module as viewed from a fuel electrode side;

FIG. 5 is a top view of part of a horizontal cross-section taken along line B-B in FIG. 3;

FIG. 6 is a side view of part of a vertical cross-section taken along line A-A in FIG. 3;

FIG. 7 is a partial exploded perspective view of a portion of a separator of the cell module;

FIG. 8 is a partial perspective view of a portion of a separator,

FIG. 9 is a top view of representative example shapes of the mesh of the separator;

### DETAILED DESCRIPTION OF THE PREFERRED EMBODIMENTS

The present invention is particularly effective when applied to a polymer electrolyte fuel cell that produces water as a result of a reaction between a fuel gas and an oxidizing gas. More particularly, the present invention is effective when applied to a separator provided in contact with a gas diffusion layer on an air electrode side from which water that was produced is discharged. That is, when water that was produced in the gas diffusion layer or water that was supplied adheres to the mesh of the mesh wire and forms of a large water droplet that remains there, it disrupts the supply of reaction gas to the gas supply passage downstream of the portion where the water droplet is adhered. According to the present invention, however, air holes are provided in the side portions of the waves of the spacer plates. As a result, gas can be supplied from an adjacent gas supply passage via the air holes, and therefore bypass the portion where water droplet is adhered. As a result, it is possible to prevent a decrease in the efficiency that would otherwise occur due to uneven gas diffusion.

Furthermore, the side portions of the waves of the spacer plates are preferably made of the same type mesh that the gas diffusion portions are made of, and the openings of the mesh preferably serve as the air holes. According to this structure, the gas diffusion portions of the spacer plates and the side portions of the waves that separate the gas passages can be made one continuous mesh configuration, thereby simplifying the structure of the spacer plates.

### First Embodiment

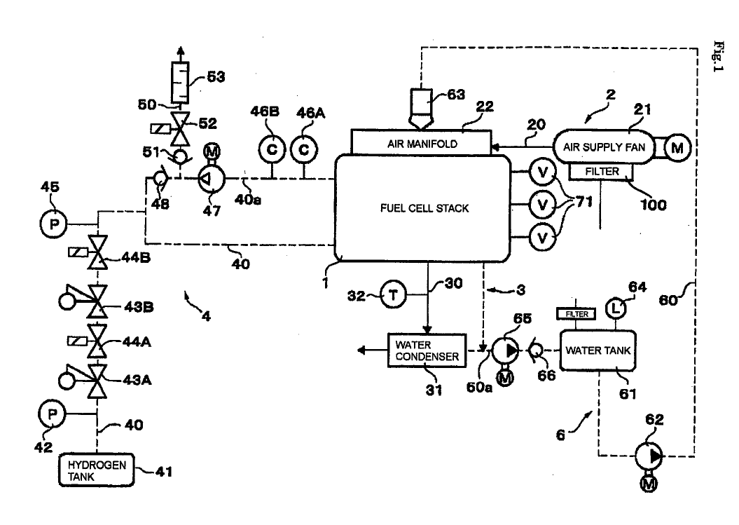

Hereinafter, exemplary embodiments of the present invention will be described with reference to the appended drawings. First, FIGS. 1 to 7 illustrate a first exemplary embodiment of the present invention. FIG. 1 is an example of a diagram of a vehicular fuel cell system which uses a fuel cell stack 1 according to one application of the present invention. The fuel cell stack 1 serves as the main component of the fuel cell system which also includes a fuel cell main portion, a fuel supply system 4, and a water supply system 6. The fuel cell main portion includes i) an air supply system (indicated by the solid lines in the drawing) 2 including an air fan 21 which serves as an air supply mechanism that supplies air to the fuel cell stack 1, and ii) an air exhaust system 3 including a water condenser 31. The fuel supply system 4 (indicated by the alternate long and two short dashes line in the drawing) includes a hydrogen tank 41 which serves as a hydrogen supply mechanism. The water supply system 6 (indicated by the broken line in the drawing) serves to moisten and cool the reaction portion. The air fan 21 disposed in the main portion of the fuel cell is connected to an air manifold 22 via an air supply line 20. The air manifold 22 is in turn connected to a case, not shown, which houses the fuel cell stack. The water condenser 31 is interposed in an air discharge line 30 of the case and connected to the fuel cell stack 1. An exhaust temperature sensor 32 is arranged in the air discharge line 30.

The fuel supply system 4 is provided in order to deliver hydrogen stored in the hydrogen tank 41 to hydrogen passages in the fuel cell stack 1 via the hydrogen supply line 40. Provided in the hydrogen supply line 40 are, in order from the hydrogen tank 41 side to the fuel cell stack 1 side, a primary pressure sensor 42, a pressure regulating valve 43A, a supply electromagnetic valve 44A, a pressure regulating valve 43B, a supply electromagnetic valve 44B, and a secondary pressure sensor 45. Incidentally, a hydrogen return line 40a and a hydrogen discharge line 50 are also provided in the hydrogen supply line 40. Arranged in the hydrogen return line 40a, in order from the fuel cell stack 1 side, are hydrogen concentration sensors 46A and 46B, a suction pump 47, and a check valve 48. A portion of the hydrogen return line 40a that is downstream of the check valve 48 is connected to the hydrogen supply line 40. The hydrogen discharge line 50 is connected to the hydrogen return line 40a between the suction pump 47 and the check valve 48. A check valve 51, a discharge electromagnetic valve 52, and a combustor 53 are provided in the hydrogen discharge line 50.

The water supply system 6 is provided in order to deliver water stored in a water tank 61 to multiple nozzles 63 disposed in the air manifold 22 of the fuel cell stack 1 via a water supply line 60. A pump 62 is arranged in the water supply line 60. Also, a level sensor 64 is disposed in the water tank 61. The water supply system 6 also has a water return line 60a that connects the fuel cell stack 1 to the water tank 61. A pump 65 and a check valve 66 are arranged in the water return line 60a. The water return line 60a is connected to the water condenser 31 at the upstream side of the pump 65. Voltage meters 71 in the drawing monitor the back electromotive voltage of the fuel cell.

When the fuel cell system of the foregoing structure is operating, the air supply fan 21 supplies air to the air manifold 22, the pump 62 supplies water from the water supply system, and the supply electromagnetic valves 44A and 44B supply hydrogen from the fuel supply system 4.

At this time, in the fuel supply system 4, the hydrogen primary pressure sensor 42 monitors the hydrogen pressure on the hydrogen tank 41 side, and the hydrogen regulating valves 43A and 43B regulate the pressure so that it is suitable for being supplied to the fuel cell stack 1. The supply of hydrogen to the fuel cell stack 1 is then electrically controlled by opening or closing the supply electromagnetic valves 44A and 44B. The supply of hydrogen gas can be interrupted by closing the supply electromagnetic valves 44A and 44B. Further, the hydrogen secondary pressure sensor 45 monitors the hydrogen gas pressure immediately before the hydrogen gas is supplied to the fuel cell stack 1. Also, in the water supply system 6, the pump 62 delivers water from the water tank 61 to the nozzles 63 provided in the air manifold 22. From here, the water is either continuously or intermittently injected into the air manifold 22, where it mixes as mist with the air flow and is delivered into the fuel cell stack 1.

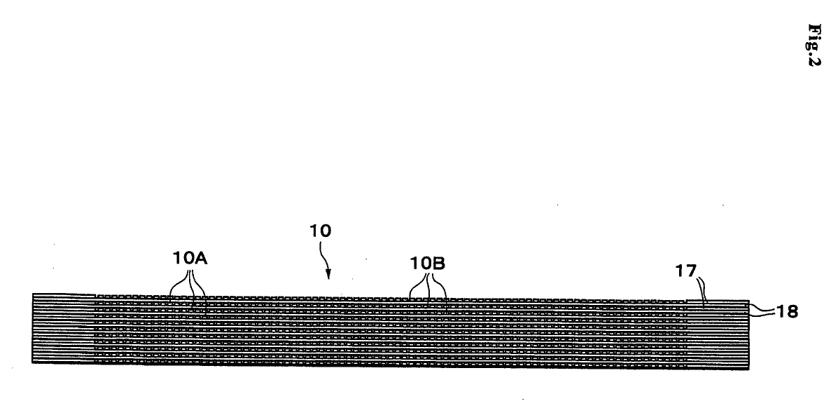

FIGS. 2 to 7 show the structure of a cell module 10, which is the unit of which the fuel cell stack 1 in the fuel cell system of the foregoing structure is formed. As shown by the top surface in FIG. 2 (hereinafter, the top/bottom and vertical/horizontal relationships in view of the position in which the cell module is arranged will be described), the cell module 10 is formed of a plurality of sets (the example in the drawing shows 10 sets) stacked together in the direction of thickness, each set including a single cell (MEA) 10A, a separator 10B which electrically connects pairs of single cells together and separates the flow passage of the hydrogen gas introduced into the single cells from the air flow passage, and two kinds of frames 17 and 18 that support the single cells 10A and the separator 10B.

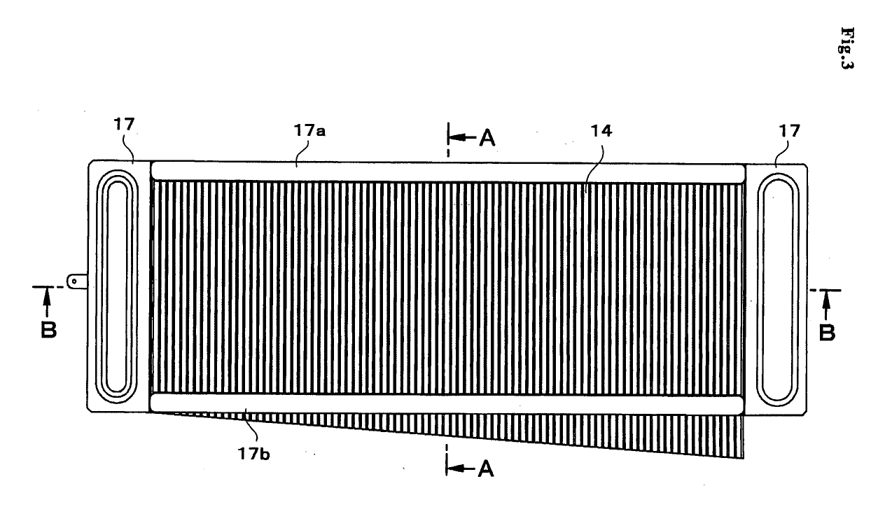

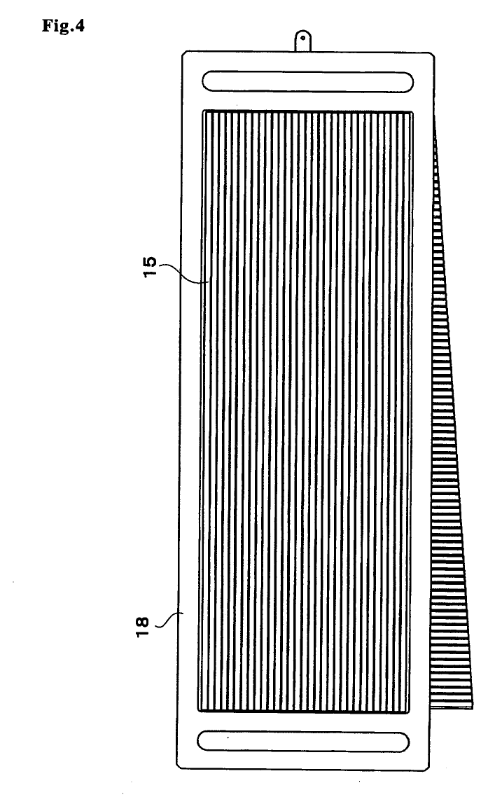

The single cell 10A is positioned inside of the frame 18 so it is not clearly visible in FIG. 2. The cell module 10 is such that the single cells 10A and the separators 10B are stacked with the two kinds of frames 17 and 18 stacked alternately in multiple levels such that the single cells 10A are arranged a predetermined distance away from each other. One end, in direction of stacking, of the cell module 10, (i.e., the upper end side in FIG. 2) ends with the surface of the separator 10B that has protrusions formed in the vertical direction and the end face of one frame 17, as shown in FIG. 3. The other end (the lower end side in FIG. 2) of the cell module 10 ends with the surface of the separator 10B that has protrusions formed in the horizontal direction and the end face of the other frame 18, as shown in FIG. 4.

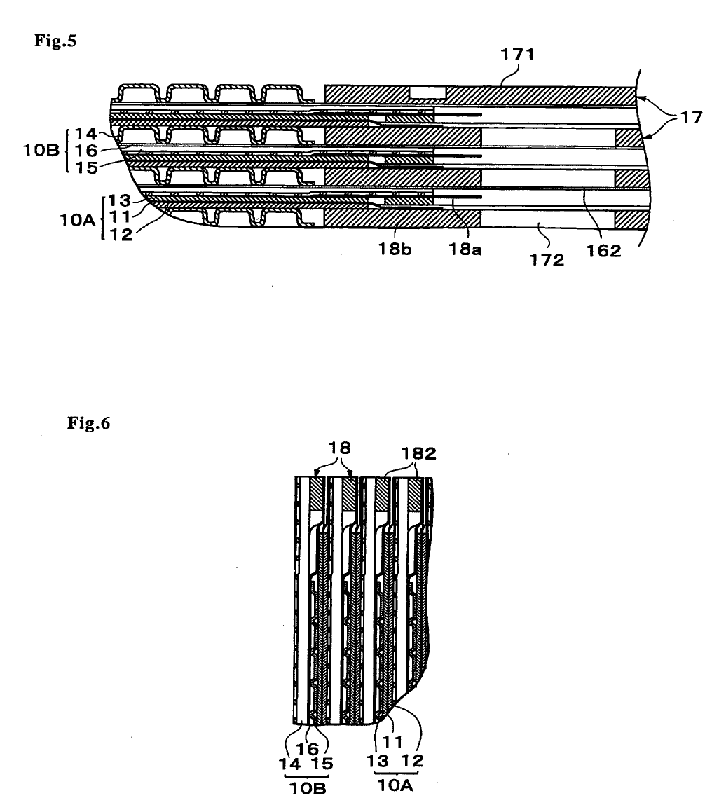

As shown in the exploded sectional diagrams of FIGS. 5 and 6, the single cell 10A includes a polymer electrolyte membrane 11, an air electrode 12 which is an oxidant electrode provided on one side of the polymer electrolyte membrane 11, and a fuel electrode 13 provided on the other side of the polymer electrolyte membrane 11. The air electrode 12 and the fuel electrode 13 are formed of a gas diffusion layer of conductive material such as carbon cloth through which the reaction gas permeates while diffusing, as described above, and a catalyst layer including catalyst material sandwiched between this diffusion layer and the polymer electrolyte membrane 11. Of these members, the air electrode 12 and the fuel electrode 13 have horizontal dimensions that are slightly longer than the width of an open portion of the frame 18 which serves as a support member for the air electrode 12 and the fuel electrode 13, and vertical dimensions that are slightly shorter than the height of that open portion. Further, the polymer electrolyte membrane 11 has vertical and horizontal dimensions which are one size larger than the vertical and horizontal dimensions of the open portion.

The separator 10B includes an imperforate separator substrate 16 which serves as a gas interrupting member between single cells 10A, and spacer plates 14 and 15 which are interposed between the electrodes 12 and 13 and the separator substrate 16.

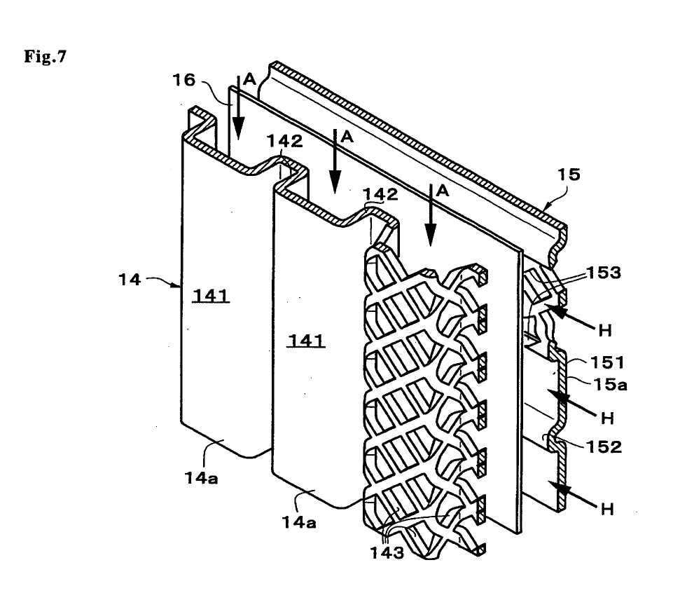

As shown in detail in the exploded view of FIG. 7, the spacer plates (hereinafter, the spacer plate on the air electrode side will be referred to as the “air electrode side collector” and the spacer plate on the fuel electrode side will be referred to as the “fuel electrode side collector”) 14 and 15 are formed of mesh and have rectangular wave-shaped cross-sections. The top portions of the rectangular waves which abut against the electrodes serve as gas diffusion portions 141 and 151, and the adjacent side portions and portions between waves together are rectangular and serve as spacer portions 142 and 152 which define a plurality of gas passages (A and H) between the gas diffusion portions 141 and 151 and the separator substrate 16. Air holes 143 and 153 which provide intercommunication between adjacent gas passages are provided in the spacer portions.

In this exemplary embodiment, aligning the opening positions of the air holes 143 and 153 with the rectangular wave shapes makes forming the separator substrate 16 particularly complicated, so the separator substrate 16 is formed of a mesh member which has evenly-spaced air holes throughout its entire surface.

In order to maintain a predetermined positional relationship of the separator substrate 16, the air electrode side collector 14, and the fuel electrode side collector 15, as well as the single cell 10A, the frame 17 is arranged on both the left and right sides of the air electrode side collector 14 (i.e., the frame 17 forms a frame (see FIG. 3) in which the top and bottom ends of the frame are interconnected by backup plates 17a and 17b on the outermost side only), and the frame 18 is provided on the peripheral edge portions of the fuel electrode side collector 15 and the single cell 10A.

In this example, the collectors 14 and 15 formed of mesh members that form the gas diffusion portions and the spacer portions in the present invention are made of thin metal plates of expanded metal which has a thickness on the order of 0.2 mm, for example. Also, the separator substrate 16 is formed of an even thinner thin metal plate. The metal may be, for example, a metal that is conductive and anticorrosive, such as stainless steel, a nickel alloy, a titanium alloy, or one of those metals that has been, for example, gold plated or otherwise treated for anticorrosion and conductibility. The frames 17 and 18 are made of suitable insulating material.

The overall shape of the air electrode side collector 14 is rectangular and horizontally long (the bottom side, however, is slanted in order to improve the draining effect). As shown in detail in the enlarged portion in FIG. 7, the air electrode side collector 14 is a wavy plate made from a mesh plate member (in the drawing, only a portion is shown as mesh in order to make it easier to see the shape of the plate surface) which has diamond-shaped air holes 143 with an aperture ratio of 59% and small protrusions 14a that have been formed by press working.

These protrusions 14a are arranged so that they travel the entire vertical length of the plate surface and are equidistant and parallel to the vertical sides (i.e., the short sides in the example shown in the drawing) of the plate member. As a result, gas flow paths are formed behind the protrusions which enable the flow rate at each portion to be the same due to the fact that the protrusions 14a are divided in a parallel fashion. The cross-sections of the protrusions 14a are roughly rectangular wave shaped, with the base side being slightly wider at the bottom due to die extraction during press working. The height of the protrusions 14a is substantially equal to the thickness of the frame 17. As a result, air flow paths A of a predetermined open area which run in the vertical direction between the frames 17 on both sides in a stacked state are ensured. Further, the ratio of the width of the protrusions 14a to the bottom portions is made equal to, or less than, 4:1 because the contact area decreases, resulting in an increase in the power collection resistance, the wider the bottom portions are with respect to the protrusions 14a.

The flat surface of a top portion 141 of each protrusion 14a serves as an abutting portion, i.e., a gas diffusion portion, which contacts the diffusion layer on the air electrode 12 side. Portions that extend in a direction intersecting with the surface of the gas diffusion electrode between protrusions 14a and the bottom portions that connects those portions together form spacer portions 142 which ensure the sectional area of the gas passage A. The bottom portions serve as abutting portions which conduct electricity between the collector 14 and the separator substrate 16.

The fuel electrode side collector 15 is made of a rectangular mesh plate member (in the drawing, only a portion is shown as mesh in order to make it easier to see the shape of the plate surface) which has cancellate diamond-shaped air holes 153 of dimensions the same as those of the air electrode side collector 14. A plurality of protrusions 15a are extrusion formed by press working. The protrusions 15a are such that top portions 151 are flat and the cross-sectional shape is one of substantially rectangular waves, just like the protrusions 14a earlier. The protrusions 15a of this collector 15, however, travel the entire width, horizontally, of the plate surface at equal distances in the vertical direction. In this case as well, gas flow paths are formed behind the protrusions which enable the flow rate at each portion to be the same due to the fact that the protrusions 15a are divided in a parallel fashion. Further, the ratio of the width of the protrusions 15a to the bottom portions is made equal to, or less than, 4:1 because the contact area decreases, resulting in an increase in the power collection resistance, the wider the bottom portions are with respect to the protrusions 15a.

The flat surface of the top portion 151 of each protrusion 15a serves as an abutting portion, i.e., a gas diffusion portion, which contacts the fuel electrode 13. Portions that extend in a direction intersecting the surface of the gas diffusion electrode between protrusions 15a and the bottom portions that connect those portions together form spacer portions 152 which ensure the sectional area of a gas passage H. The bottom portions serve as abutting portions which conduct electricity between the collector 15 and the separator substrate 16. The cross-sections of the protrusions 15a are also roughly rectangular wave shaped, with the base side being slightly wider at the bottom due to die extraction during press working. The height of the protrusions 15a, together with the thickness of the single cell 10A, essentially corresponds to the thickness of the frame 18. As a result, fuel flow paths of a predetermined open area which run horizontally through the inside of the frame 18 when they are stacked are ensured.

Both of the collectors 14 and 15 of the foregoing structures are arranged so as to sandwich the separator substrate 16 in between them with the protrusions 14a and 15a both facing outside. At this time, the bottom portions of the protrusions 14 and 15 of both the collectors 14 and 15 abut against the separator substrate 16, thereby enabling electricity to pass both ways. Also, by having the collectors 14 and 15 sandwich the separator substrate 16, the air flow paths A are formed on the back side of the portions of the collector 14 that cover the surface of the gas diffusion electrode on one side of the separator substrate 16, while the fuel flow paths H are formed as a result of the same positional relationship on the other side of the separator substrate 16. Air and water are then supplied to the air electrode 12 of the single cell 10A from the vertical air flow paths A, while hydrogen is similarly supplied to the fuel electrode 13 of the single cell 10A from the horizontal fuel flow paths H.

The frames 17 and 18 are each arranged on the outside of the separator 10B structured as described above. As shown in FIGS. 5 and 6, with the exception of the portion on the outer end (the upper-most portion in FIG. 5 and the left end in FIG. 6), the frame 17 which surrounds the collector 14 includes only vertical frame portions 171 that surround both sides along the short sides of the collector 14, and through which long holes 172 are provided in the direction of plate thickness in order to form fuel flow paths. The plate thickness of the frame 17 is comparable to the thickness of the wavy-shaped collector 14, as described above. Therefore, when the frame 17 and the collector 14 are together, the protrusions 14a of the collector 14 are in contact with the air electrode 12 of the single cell 10A, while the bottom portions are in contact with the collector 15 via the separator substrate 16. The separator substrate 16 has outer dimensions that correspond to the height and entire width of the frame 17, and is provided with similar long holes 162 in positions that overlap with the long holes 172 in the frame 17. Thus, the air flow paths A that are surrounded by the separator substrate 16 and the air electrode 12 surface of the single cell 10A and which pass vertically through the entire single cell unit are established between both vertical frame portions 171 of the frame 17.

The frame 18 that surrounds the collector 15 and the single cell 10A is the same size as the frame 17, but differs from the frame 17 in that it is a complete frame that includes both left and right vertical frame portions (although not shown in FIG. 5 due to the fact that they are farther to the right than the drawing shows, they are frame portions with the ends on both sides in the same positions as the left and right side ends of both vertical frame portions 171 of the frame 17, and a width in the horizontal direction substantially the same as that of top and bottom horizontal frame portions) and top and bottom horizontal frame portions 182. With the exception of the portion on the outer end (the lower-most portion in FIG. 2, i.e., the surface shown in FIG. 4), the frame 18 includes a thin backup plate 18a that extends parallel to the left and right vertical frame portions and overlaps with the left and right ends of the collector 15, and a thick backup plate 18b. The space surrounded by these backup plates 18a and the vertical frame portions forms the fuel flow path which is aligned with the long holes 172 that pass through the frame 17 in the direction of plate thickness.

The plate thickness of the frame 18 is comparable to the thickness of the wavy shaped collector 15, as described above. Therefore, when the frame 18 and the collector 15 are together, the protrusions 15a of the collector 15 are in contact with the fuel electrode 13 of the single cell 10A, while the bottom portions are in contact with the collector 14 via the separator substrate 16. Thus, the fuel paths H are formed in the stacking direction aligned with the long holes 172 in the vertical frame portions 171 of the frame 17 between both vertical frame portions of the frame 18 and the backup plate 18a. Further, the fuel flow paths H which are horizontal flow paths sandwiched between the separator substrate 16 and the backup plate 18a are defined by the wavy shape of the collector 15 on the inside each frame 18.

The separator 10B is formed with the collectors 14 and 15 and the separator substrate 16 being retained by the frames 17 and 18 of the above described structures. A cell module is then formed by alternately stacking the separators 10B with the single cells 10A. As shown in FIG. 2, slit-shaped air flow paths are thus formed, which travel through the entire cell module in the vertical direction, from the top surface of the cell module to the bottom surface of the cell module, in the portions that are sandwiched between the frames 18 in the stacked cell modules.

The fuel cell stack (see FIG. 1) which is formed by arranging a plurality of individual cell modules of the foregoing structure together in a case generates power by supplying air and water, which have mixed in the air manifold 22, from the top portion of the fuel cell stack 1 and hydrogen from the side. The air and water supplied to the air flow paths enter the top portion of the air flow paths in a state in which water droplets are mixed with the air flow in the form of mist (hereinafter, this state will be referred to as “mixed flow”). During steady operation of the fuel cell, the mixed flow within the air flow paths becomes heated due to the heat generated by the single cell 10A from the reaction. Some of the water droplets in the mixed flow adhere to the mesh of the collector 14. The water droplets that do not adhere to the mesh of the collector 14 are heated in the vapor phase between the collector 14 and the gas diffusion layer and evaporate, such that a latent heat cooling effect is produced which removes heat from the collector 14. This water which has become vapor retains humidity, thus suppressing evaporation of the moisture within the polymer electrolyte membrane 11 from the air electrode 12 side. The excess air, vapor, and water that have entered to air flow paths are then discharged from the openings of the air flow paths at the bottom of the cell stack.

On the other hand, the hydrogen is supplied to the fuel flow paths from the long holes in the vertical frame portions of the frame 18 on the outermost side shown in FIG. 4. It then flows into the spaces surrounded by the vertical and horizontal frame portions of each frame 18 and the backup plates 18a via the long holes 172 in the vertical frame portions 171 of the frame 17, and is supplied to the fuel electrode 13 side of the single cell 10A via the spaces sandwiched between the separator substrate 16 and the backup plate 18a. As a result, hydrogen is supplied to the fuel electrode 13 of the single cell 10A. Of the hydrogen that flows in the horizontal direction along the fuel electrode 13, the excess portion that did not contribute to the reaction is discharged to the hydrogen flow paths on the opposite side and recirculated by the pipe shown in FIG. 1 that is connected to the hydrogen flow path, and finally discharged to the combustor.

Thus, as described above, some of the water that is delivered together with the air to the fuel cell stack adheres to the mesh of the collector 14 and evaporates, while the rest evaporates without adhering to the mesh in the gas phase and removes latent heat, thus preventing the evaporation of moisture from the electrolyte membrane 11 on the air electrode 12 side. As a result, the electrolyte membrane 11 is constantly maintained in a uniformly moist state by the produced water without drying on the air electrode side 12. Also, the water supplied to the surface of the air electrode 12 removes heat from the air electrode 12 itself, thereby cooling it. As a result, the temperature of the fuel cell stack 1 can be controlled.

The flow of hydrogen within the fuel cell stack 1 is as described above. In the fuel supply system 4, the concentration of the hydrogen gas discharged from the hydrogen passage of the fuel cell stack 1 by the suction of the pump 47 is measured by the concentration sensors 45A and 45B. When the measured concentration is equal to, or greater than, a predetermined concentration, the hydrogen gas is recirculated to the hydrogen supply line 40 via the recirculation check valve 48 by closing the electromagnetic valve 52. When the measured concentration is less than the predetermined concentration, on the other hand, the hydrogen is discharged to the combustor 53 via the check valve 51 and the electromagnetic valve 52 by intermittently opening the discharge electromagnetic valve 52, such that exhaust which has been completely combusted by the combustor 53 is released to the outside air. With this system, the fuel cell stack 1 can be sufficiently wet and cooled by supplying water to the fuel cell stack 1 in the air flow, even without providing a cooling system. At this time, the temperature of the fuel cell stack 1 can be maintained at the desired temperature by controlling the amount of water injected from the nozzles 63 into the air manifold 22. This can be done by suitably controlling the output and operating intervals of the pump 62 depending on the temperature of the exhausted air detected by the exhaust temperature sensor 32. More specifically, the evaporation amount increases when the amount of water supplied to the fuel cell stack 1 is increased, and decreases when the amount of water supplied to the fuel cell stack 1 is decreased. Similarly, the temperature decreases when the airflow is increased, and increases when the airflow is decreased. Therefore, the operating temperature can be controlled by controlling the amount of water and airflow supplied. Water that is discharged together with air from the fuel cell stack 1 is discharged with most of it being in a liquid state. Therefore, that water flows to the water return line 60a, is drawn up by the pump 65 and returned to the water tank 61 via the check valve 66. The water that has evaporated and is therefore in the form of vapor, or water that is not recovered to the water return line 60a is condensed by the water condenser 31 so that it is liquefied, and then drawn up by the pump 65 and returned to the water tank 61. Some of the water vapor in the exhausted air is thought to come from the reaction water following a power generating reaction of the fuel cell stack 1. The water level in the water tank 61 is monitored by the water level sensor 64.

This system has several characteristics. First, the collectors 14 and 15 are fine mesh with air holes formed over the entire contact surface that is in contact with the gas diffusion layer, such that a mixed flow of air and water becomes agitated when it passes through the air holes, and a mixed gas is supplied to a contact surface of the gas diffusion layer that is in contact with the collectors 14 and 15. As a result, air can be evenly supplied to the entire electrode surface in the fuel cell stack 1, thereby making it possible to reduce the concentration polarization. Also, contact at the mesh between the electrode and the collector enables power to be collected evenly from the entire electrode, so power collection resistance is reduced. Furthermore, the catalyst of the entire electrode can be used effectively so the activation polarization is reduced. This system is also advantageous in that the effective area of the electrode can be increased.

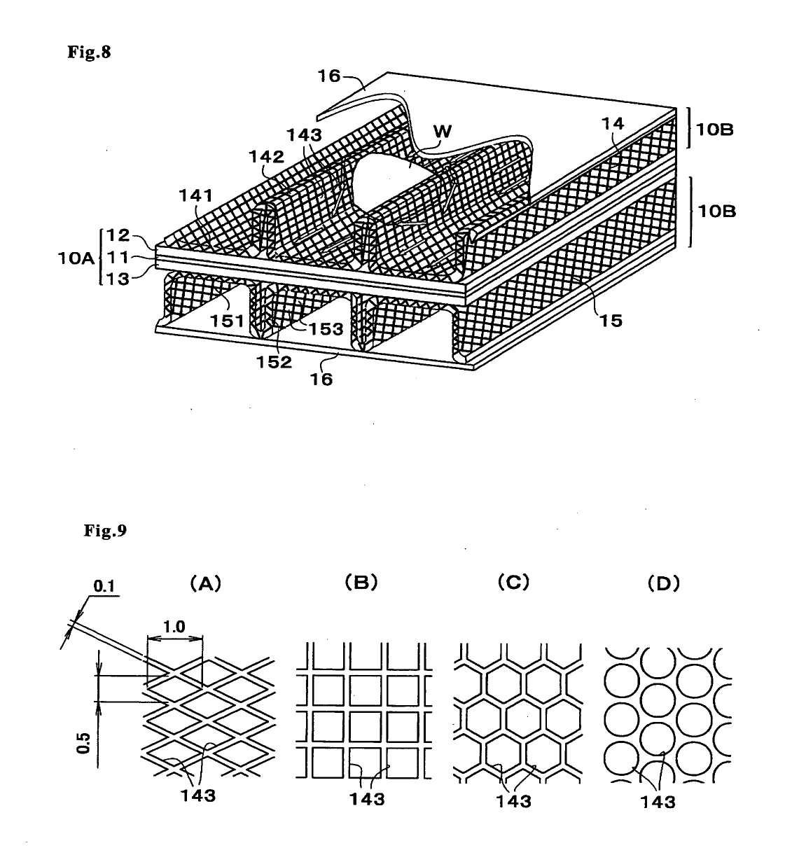

FIG. 8 shown next illustrates the operation according to the structure of the exemplary embodiment. When a large water droplet W adheres to the mesh and remains there in a gas passage (such as the center passage of the three passages shown in the drawing), as shown in the drawing, this water droplet W remains until it evaporates by the heat from the spacer plate 14. In this case, the gas passage becomes narrower or blocked at this portion, thereby interrupting the supply of gas to the gas passage downstream of that portion. With the present invention, however, there are air holes 143 formed by the mesh at the side portions of the waves of the separator plate 14. As a result, gas upstream of the water droplet W flows out into other adjacent gas passages through the air holes 143 due to increased pressure on the other gas passages (i.e., the two gas passages on both sides), as shown by the white arrows in the drawing, thereby making it possible to prevent the gas from being detained upstream in the flow path.

Also, downstream of the water droplet W in the passage, the pressure on the other gas passages drops, so the gas conversely flows back into the center passage from the adjacent passages through the air holes 143. As a result, it is possible to eliminate a gas supply shortage downstream in a passage that has a localized constriction or block.

Thus, according to the exemplary embodiment, the gas passages which are divided due to the shape of the spacer plate 14 which has a rectangular wave-shaped cross-section are intercommunicated by the air holes 143. Therefore, even if water remains in the form of a water droplet on the electrode on the oxidation electrode side so that a gas passage becomes narrow or blocked, gas can bypass that portion and be supplied through the air holes from an adjacent flow path. As a result, gas can be diffused evenly to the electrode past the narrow or blocked portion.

In the first exemplary embodiment described above, an example was described in which the mesh of the collectors 14 and 15 of the separator is diamond-shaped. The mesh of the collectors 14 and 15 is not limited to being diamond-shaped, however. Alternatively, it may be any of a variety of shapes. FIG. 8 shows representative example shapes of the air holes. Regardless of which shape is employed, the fact that the distance between any two adjacent air holes is constant is effective for making the gas diffusion even. It is also desirable that the distance between edges of adjacent air holes also be substantially constant in order to prevent the air holes from clogging due to water adhering to the mesh, particularly at the collector 14.

The example illustrated in FIG. 9(A) shows diamond-shaped mesh of an expanded metal that has been applied to the first exemplary embodiment. With this shape, when the dimension in the horizontal direction of the opening 143 (hereinafter, only the reference numerals of the collector 14 will be noted) which is an air hole is, for example, 1 mm, the dimension in the vertical direction is 0.5 mm, and the width of the edge portions between openings is 0.1 mm, the aperture ratio is 68.4%. This opening shape can also be realized with a screen of bent wire.

The example illustrated in FIG. 9(B) is one example of rectangular openings, and shows punched metal mesh in which square air holes 143 have been punched out. In this example, the opening pitch of the air holes 143 is the same in both the vertical and horizontal directions, resulting in a vertical and horizontal lattice-shaped mesh. Alternatively, however, a similar opening ratio can also be achieved by an arrangement in which the opening positions are offset half a pitch in the vertical or horizontal direction. This opening shape can also be realized with a screen of bent wire.

The example illustrated in FIG. 9(C) is one example of polyangular openings, and shows punched metal mesh in which air holes 143 having six sides each have been punched out. In this example, the mesh is honeycomb shaped. This opening shape can also be realized with a screen of bent wire.

The example illustrated in FIG. 9(D) shows punched metal mesh in which circular air holes 143 have been punched out. It is the simplest example of round openings. In this case, the opening pitch of the air holes 143 is set such that the distance between the centers of any two adjacent air holes is the same. As a result, a generally lattice-shaped mesh having a large aperture ratio is formed. With this shape, an exceptional effect is achieved when the aperture ratio is 25% or greater and the hole diameter is 0.5 to 1.0 mm, inclusive.

1. A separator which is inserted between single cells of a fuel cell, each single cell having an electrolyte containing water sandwiched between electrodes, in order to stack the single cells together, comprising:
an imperforate separator substrate and spacer plates that are interposed between the electrodes and the separator substrate,
wherein the spacer plates are formed of mesh and have rectangular wave-shaped cross-sections, top portions of the rectangular waves that abut against the electrodes serving as gas diffusion portions and adjacent side portions and portions between waves together being rectangular and serving as spacer portions which define a plurality of gas passages between the gas diffusion portions and the separator substrate, and air holes that provide intercommunication between adjacent gas passages being provided in the spacer portions.

2. The separator according to claim 1, wherein the air holes of the spacer portions are formed in a network.

3. A fuel cell in which single cells of the fuel cell, each single cell having an electrolyte which contains water sandwiched between electrodes, are stacked together with a separator sandwiched in between, wherein the separator includes an imperforate separator substrate and spacer plates that are interposed between the electrodes and the separator substrate, and the spacer plates are formed of mesh and have rectangular wave-shaped cross-sections, top portions of the rectangular waves that abut against the electrodes serving as gas diffusion portions and adjacent side portions and portions between waves together being rectangular and serving as spacer portions which define a plurality of gas passages between the gas diffusion portions and the separator substrate, and air holes that provide intercommunication between adjacent gas passages being provided in the spacer portions.

4. The fuel cell according to claim 3, wherein the air holes are formed in a network of wire mesh.
